(19) United States
(12) Patent Application Publication
(10) Pub. No.: US 2024/0056563 A1
(43) Pub. Date: Feb. 15, 2024

(54) Transparent Display with Blur Effect for Physical Objects

(71) Applicant: Apple Inc., Cupertino, CA (US)

(72) Inventors: Rahul Nair, Hayward, CA (US); Giancarlo Yerkes, San Francisco, CA (US)

(21) Appl. No.: 18/339,098

(22) Filed: Jun. 21, 2023

Related U.S. Application Data
(60) Provisional application No. 63/397,604, filed on Aug. 12, 2022.

(51) Int. Cl. H04N 13/332; G06T 5/00; G06T 3/40

(52) U.S. Cl. CPC H04N 13/332; G06T 5/006; G06T 5/002; G06T 3/40; G06T 2207/20132; G06T 2207/10016

(57) ABSTRACT

To blur the physical environment viewable through a transparent display, a system may capture images of the physical environment using a camera, warp the images of the physical environment from the perspective of the camera to the perspective of a user's eye, and display a blurred version of the warped images. The transparent display overlays a blurred version of the physical environment over the physical environment such that the physical environment appears blurred. This type of blur effect may be applied across the entire physical environment that is viewable through the transparent display or across only a subset of the physical environment that is viewable through the transparent display.

This application claims priority to U.S. provisional patent application No. 63/397,604, filed Aug. 12, 2022, which is hereby incorporated by reference herein in its entirety.

### BACKGROUND

This disclosure relates generally to electronic devices and, more particularly, to electronic devices with transparent displays.

Some electronic devices include transparent displays that present images close to a user's eyes. The transparent displays permit viewing of a user's physical environment through the transparent display. For example, extended reality headsets may include transparent displays.

### SUMMARY

A method of operating a head-mounted device with a camera and a display may include capturing an image of a physical environment using the camera, emitting light from a transparent structure towards an eye box using the display, wherein the physical environment is viewable through the transparent structure from the eye box, warping the image of the physical environment from a perspective of the camera to a perspective of the eye box, and displaying, using the display, a blurred portion of the warped image of the physical environment at a position that overlaps a corresponding portion of the physical environment.

An electronic device may include a head-mounted support structure, a camera coupled to the head-mounted support structure, wherein the camera is configured to capture an image of a physical environment, a display coupled to the head-mounted support structure, wherein the display emits light from a transparent structure towards an eye box and wherein a subset of the physical environment is viewable through the transparent structure from the eye box, and control circuitry configured to, using the image of the physical environment captured by the camera, display a blurred image of the subset of the physical environment that overlaps the subset of the physical environment when viewed through the transparent structure from the eye box.

### BRIEF DESCRIPTION OF THE DRAWINGS

FIG. 1 is a diagram of an illustrative system having a display in accordance with some embodiments.

FIG. 2A is a view of an illustrative transparent display that overlaps a physical environment in accordance with some embodiments.

FIG. 2B is a view of an illustrative transparent display that overlaps and applies a blur effect to at least some of a physical environment in accordance with some embodiments.

FIG. 3A is a top view of an illustrative system with a transparent display and cameras in accordance with some embodiments.

FIG. 3B is a side view of an illustrative system with a transparent display and cameras in accordance with some embodiments.

FIG. 4 is a diagram showing an illustrative field of view of a camera relative to a field of view of an eye looking through a transparent display in accordance with some embodiments.

FIG. 5 is a flowchart of an illustrative method performed by a system in accordance with some embodiments.

FIGS. 6A-6E are views of illustrative transparent displays with blur panels in various arrangements in accordance with some embodiments.

### DETAILED DESCRIPTION

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

Head-mounted devices may display different types of extended reality content for a user. The head-mounted device may display a virtual object that is perceived at an apparent depth within the physical environment of the user. Virtual objects may sometimes be displayed at fixed locations relative to the physical environment of the user. For example, consider an example where a user's physical environment includes a table. A virtual object may be displayed for the user such that the virtual object appears to be resting on the table. As the user moves their head and otherwise interacts with the XR environment, the virtual object remains at the same, fixed position on the table (e.g., as if the virtual object were another physical object in the XR environment). This type of content may be referred to as world-locked content (because the position of the virtual object is fixed relative to the physical environment of the user).

Other virtual objects may be displayed at locations that are defined relative to the head-mounted device or a user of the head-mounted device. First, consider the example of virtual objects that are displayed at locations that are defined relative to the head-mounted device. As the head-mounted device moves (e.g., with the rotation of the user's head), the virtual object remains in a fixed position relative to the head-mounted device. For example, the virtual object may be displayed in the front and center of the head-mounted device (e.g., in the center of the device's or user's field of view) at a particular distance. As the user moves their head left and right, their view of their physical environment changes accordingly. However, the virtual object may remain fixed in the center of the device's or user's field of view at the particular distance as the user moves their head (assuming gaze direction remains constant). This type of content may be referred to as head-locked content. The head-locked content is fixed in a given position relative to the head-mounted device (and therefore the user's head which is supporting the head-mounted device). The head-locked content may not be adjusted based on a user's gaze direction. In other words, if the user's head position remains constant and their gaze is directed away from the head-locked content, the head-locked content will remain in the same apparent position.

Second, consider the example of virtual objects that are displayed at locations that are defined relative to a portion of the user of the head-mounted device (e.g., relative to the user's torso). This type of content may be referred to as body-locked content. For example, a virtual object may be displayed in front and to the left of a user's body (e.g., at a location defined by a distance and an angular offset from a forward-facing direction of the user's torso), regardless of which direction the user's head is facing. If the user's body is facing a first direction, the virtual object will be displayed in front and to the left of the user's body. While facing the first direction, the virtual object may remain at the same, fixed position relative to the user's body in the XR environment despite the user rotating their head left and right (to look towards and away from the virtual object). However, the virtual object may move within the device's or user's field of view in response to the user rotating their head. If the user turns around and their body faces a second direction that is the opposite of the first direction, the virtual object will be repositioned within the XR environment such that it is still displayed in front and to the left of the user's body. While facing the second direction, the virtual object may remain at the same, fixed position relative to the user's body in the XR environment despite the user rotating their head left and right (to look towards and away from the virtual object).

In the aforementioned example, body-locked content is displayed at a fixed position/orientation relative to the user's body even as the user's body rotates. For example, the virtual object may be displayed at a fixed distance in front of the user's body. If the user is facing north, the virtual object is in front of the user's body (to the north) by the fixed distance. If the user rotates and is facing south, the virtual object is in front of the user's body (to the south) by the fixed distance.

Alternatively, the distance offset between the body-locked content and the user may be fixed relative to the user whereas the orientation of the body-locked content may remain fixed relative to the physical environment. For example, the virtual object may be displayed in front of the user's body at a fixed distance from the user as the user faces north. If the user rotates and is facing south, the virtual object remains to the north of the user's body at the fixed distance from the user's body.

Body-locked content may also be configured to always remain gravity or horizon aligned, such that head and/or body changes in the roll orientation would not cause the body-locked content to move within the XR environment. Translational movement may cause the body-locked content to be repositioned within the XR environment to maintain the fixed distance from the user. Subsequent descriptions of body-locked content may include both of the aforementioned types of body-locked content.

In some systems, it may be desirable to blur images on a display (e.g., to achieve a desired aesthetic appearance). As a specific example, a display background may be blurred while viewing a user interface element. In opaque displays, the system controls all of the light emitted from the display and therefore has the flexibility to blur some or all of the content on the display as desired. In transparent displays, however, the physical environment is viewable through the transparent display. The display may overlay content on the physical environment but does not block the physical environment from being viewable through the transparent display.

To blur the physical environment viewable through a transparent display, a system may capture images of the physical environment using a camera, optionally transform (warp) the images of the physical environment from the perspective of the camera to the perspective of a user's eye, and display a blurred version of the images. The images of the physical environment may also optionally be cropped before displaying a blurred version of images. In this way, the transparent display overlays a blurred version of the physical environment over the physical environment such that the physical environment appears blurred. This type of blur effect may be applied across the entire physical environment that is viewable through the transparent display or across only a subset of the physical environment that is viewable through the transparent display.

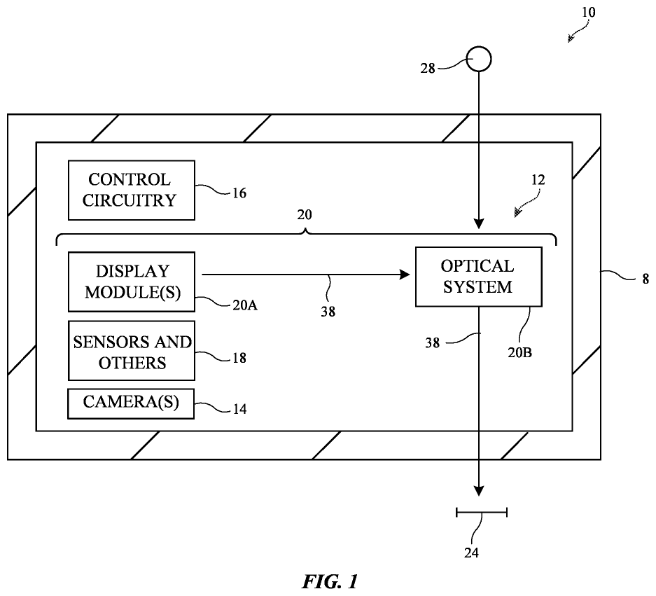

System 10 (sometimes referred to as electronic device 10, head-mounted device 10, etc.) of FIG. 1 may be a head-mounted device having one or more displays. The displays in system 10 may include displays 20 (sometimes referred to as near-eye displays) mounted within support structure (housing) 8. Support structure 8 may have the shape of a pair of eyeglasses or goggles (e.g., supporting frames), may form a housing having a helmet shape, or may have other configurations to help in mounting and securing the components of near-eye displays 20 on the head or near the eye of a user. Near-eye displays 20 may include one or more display modules such as display modules 20A and one or more optical systems such as optical systems 20B. Display modules 20A may be mounted in a support structure such as support structure 8. Each display module 20A may emit light 38 (image light) that is redirected towards a user's eyes at eye box 24 using an associated one of optical systems 20B.

The operation of system 10 may be controlled using control circuitry 16. Control circuitry 16 may be configured to perform operations in system 10 using hardware (e.g., dedicated hardware or circuitry), firmware and/or software. Software code for performing operations in system 10 and other data is stored on non-transitory computer readable storage media (e.g., tangible computer readable storage media) in control circuitry 16. The software code may sometimes be referred to as software, data, program instructions, instructions, or code. The non-transitory computer readable storage media (sometimes referred to generally as memory) may include non-volatile memory such as non-volatile random-access memory (NVRAM), one or more hard drives (e.g., magnetic drives or solid state drives), one or more removable flash drives or other removable media, or the like. Software stored on the non-transitory computer readable storage media may be executed on the processing circuitry of control circuitry 16. The processing circuitry may include application-specific integrated circuits with processing circuitry, one or more microprocessors, digital signal processors, graphics processing units, a central processing unit (CPU) or other processing circuitry.

System 10 may include input-output circuitry such as input-output devices 12. Input-output devices 12 may be used to allow data to be received by system 10 from external equipment (e.g., a tethered computer, a portable device such as a handheld device or laptop computer, or other electrical equipment) and to allow a user to provide head-mounted device 10 with user input. Input-output devices 12 may also be used to gather information on the environment in which system 10 (e.g., head-mounted device 10) is operating. Output components in devices 12 may allow system 10 to provide a user with output and may be used to communicate with external electrical equipment. Input-output devices 12 may include one or more cameras 14 (sometimes referred to as image sensors 14). Cameras 14 may be used for gathering images of physical objects that are optionally digitally merged with virtual objects on a display in system 10. Input-output devices 12 may include sensors and other components 18 (e.g., accelerometers, depth sensors, light sensors, haptic output devices, speakers, batteries, wireless communications circuits for communicating between system 10 and external electronic equipment, etc.).

Display modules 20A may be liquid crystal displays, organic light-emitting diode displays, laser-based displays, or displays of other types. Optical systems 20B may form lenses that allow a viewer (see, e.g., a viewer's eyes at eye box 24) to view images on display(s) 20. There may be two optical systems 20B (e.g., for forming left and right lenses) associated with respective left and right eyes of the user. A single display 20 may produce images for both eyes or a pair of displays 20 may be used to display images. In configurations with multiple displays (e.g., left and right eye displays), the focal length and positions of the lenses formed by system 20B may be selected so that any gap present between the displays will not be visible to a user (e.g., so that the images of the left and right displays overlap or merge seamlessly).

If desired, optical system 20B may contain a transparent structure (e.g., an optical combiner, etc.) that allows image light from physical objects 28 to be combined optically with virtual (computer-generated) images such as virtual images in image light 38. In this type of system, a user of system 10 may view both the physical environment around the user and computer-generated content that is overlaid on top of the physical environment. Cameras 14 may also be used in device 10 (e.g., in an arrangement in which a camera captures images of physical object 28 and this content is modified and presented as virtual content at optical system 20B).

System 10 may, if desired, include wireless circuitry and/or other circuitry to support communications with a computer or other external equipment (e.g., a computer that supplies display 20 with image content). During operation, control circuitry 16 may supply image content to display 20. The content may be remotely received (e.g., from a computer or other content source coupled to system 10) and/or may be generated by control circuitry 16 (e.g., text, other computer-generated content, etc.). The content that is supplied to display 20 by control circuitry 16 may be viewed by a viewer at eye box 24.

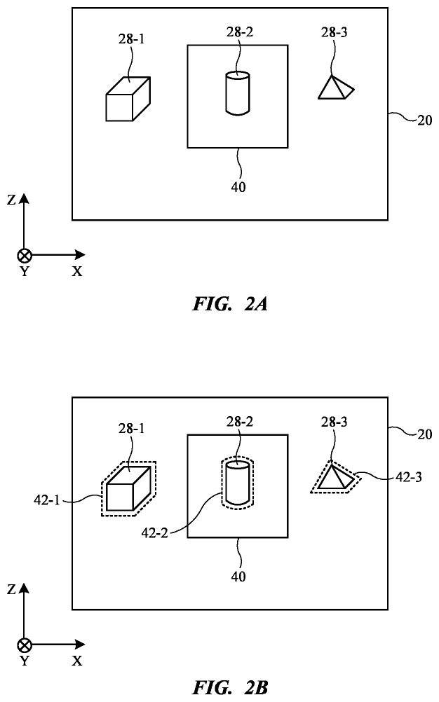

FIGS. 2A and 2B show how a blur effect may be applied to one or more physical objects in a physical environment viewed through a transparent display. FIG. 2A shows transparent display 20 as viewed by a user (e.g., an eye at eye box 24 in FIG. 1). In FIG. 2A, no blur effect is applied to the physical environment. Accordingly, physical object 28-1, physical object 28-2, and physical object 28-3 are visible through the transparent display without a blur effect (e.g., the physical objects are perceived by the user as if the transparent display was not present).

In FIG. 2A, computer-generated content 40 is displayed by transparent display 20. The computer-generated content 40 may be, as examples, a two-dimensional virtual object or a three-dimensional virtual object. The computer-generated content is overlayed over physical object 28-2 such that a user receives light from (and perceives) both physical object 28-2 and computer-generated content 40.

If desired, a blur effect may be applied to one or more portions of the physical environment viewed through the transparent display. In the example of FIG. 2B, a blur effect is applied to physical objects 28-1, 28-2, and 28-3. To achieve the blur effect for the physical objects, one or more cameras 14 (see FIG. 1) may capture images of the physical environment (e.g., including physical objects 28-1, 28-2, and 28-3). The captured images of the physical environment may be transformed (e.g., reprojected) from the perspective of the camera(s) to the perspective of the user (e.g., eye box 24). One or more portions of the captured images may then be blurred (after optional cropping) and overlayed on the physical environment using transparent display 20.

For example, one or more cameras 14 capture images of physical object 28-1 (e.g., a cube). The captured images of physical object 28-1 may be transformed (warped) from the perspective of the camera(s) to the perspective of the user (e.g., eye box 24). Transforming the images in this manner ensures that the images of the physical object 28-1 are aligned with the actual physical object when viewed from the perspective of the user. The image of the physical object 28-1 may be blurred (e.g., using Gaussian blurring). A blurred image 42-1 (sometimes referred to as a blur panel) of physical object 28-1 may subsequently be displayed on transparent display 20 in a location that aligns the blurred image 42-1 of physical object 28-1 with the actual physical object 28-1. The user therefore perceives a blurred cube when viewing the physical environment through the transparent display.

One or more cameras 14 capture images of physical object 28-2 (e.g., a cylinder). The captured images of physical object 28-2 may be transformed from the perspective of the camera(s) to the perspective of the user (e.g., eye box 24). Transforming the images in this manner ensures that the images of the physical object 28-2 are aligned with the actual physical object when viewed from the perspective of the user. The image of the physical object 28-2 may be blurred (e.g., using Gaussian blurring) and merged with other computer-generated content 40 on the display. A blurred image 42-2 of physical object 28-2 may subsequently be displayed on transparent display 20 in a location that aligns the blurred image 42-2 of physical object 28-2 with the actual physical object 28-2. Computer-generated content 40 is simultaneously displayed on the transparent display. The user therefore perceives a blurred cylinder and computer-generated content 40 when viewing the physical environment through the transparent display.

One or more cameras 14 capture images of physical object 28-3 (e.g., a pyramid). The captured images of physical object 28-3 may be transformed from the perspective of the camera(s) to the perspective of the user (e.g., eye box 24). Transforming the images in this manner ensures that the images of the physical object 28-3 are aligned with the actual physical object when viewed from the perspective of the user. The image of the physical object 28-3 may be blurred (e.g., using Gaussian blurring). A blurred image 42-3 of physical object 28-3 may subsequently be displayed on transparent display 20 in a location that aligns the blurred image 42-3 of physical object 28-3 with the actual physical object 28-3. The user therefore perceives a blurred pyramid when viewing the physical environment through the transparent display.

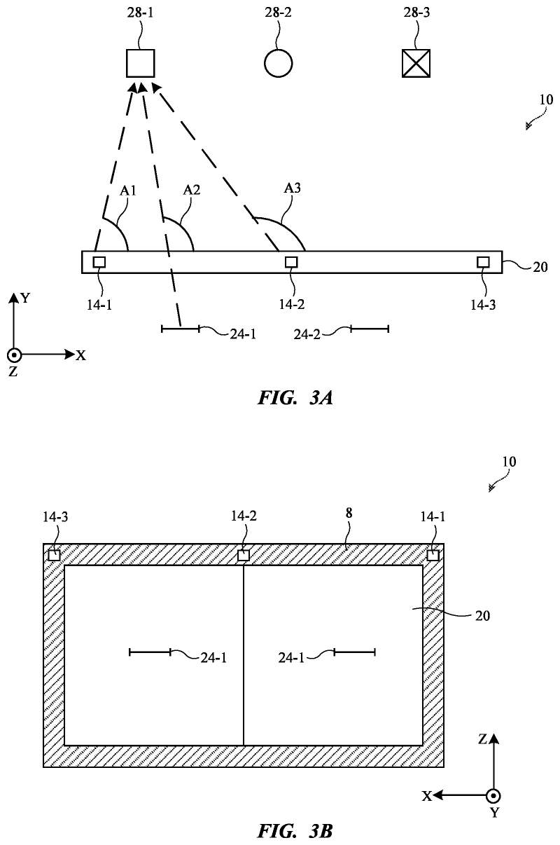

FIG. 3A is a top view of the transparent display and physical environment of FIGS. 2A and 2B. As shown in FIG. 3A, device 10 may include camera 14-1, camera 14-2, and camera 14-3. Camera 14-1 is positioned on a left side of device 10 (e.g., on the side of left eye box 24-1 for the user's left eye), camera 14-3 is positioned on a right side of the device 10 (e.g., on the side of right eye box 24-2 for the user's right eye), and camera 14-2 is positioned in the middle of the device 10 (e.g., between eye boxes 24-1 and 24-2). FIG. 3B is a front view of the device of FIG. 3A. As shown, cameras 14-1, 14-2, and 14-3 may be coupled to support structure 8 along the top of transparent display 20 (as one possible arrangement).

There is a displacement between the position of each camera and the position of each eye box. There may be a horizontal displacement (e.g., the total displacement in the X-direction), a vertical displacement (e.g., the total displacement in the Z-direction), and a depth displacement (e.g., the total displacement in the Y-direction) between each camera and eye box in system 10.

The displacement between a camera and an eye box results in different angles between the camera/eye box and a physical object in the physical environment. As shown in FIG. 3A, a vector between physical object 28-1 and camera 14-1 is at a first angle A1 relative to the transparent display 20. A vector between physical object 28-1 and eye box 24-1 is at a second angle A2 relative to the transparent display 20. A vector between physical object 28-1 and camera 14-2 is at a third angle A3 relative to the transparent display 20. Angles A1, A2, and A3 may be defined in the XY-plane and measured relative to the XZ-plane (and therefore characterize displacement along the X-axis).

If an image captured by camera 14-1 was displayed on transparent display 20 without accounting for the displacement between camera 14-1 and eye-box 24-1, the eye at eye-box 24-1 may perceive an offset between the images of the physical environment and the actual physical environment. Therefore, images from each camera may be transformed from a perspective of that camera to the perspective of an eye-box.

In some cases, a single image from a single camera may be transformed into a single image (at the perspective of eye box 24-1). For example, an image from camera 14-1 may be transformed into a single image at the perspective of eye box 24-1. In other cases, images from multiple cameras may be transformed into a single image at the perspective of eye box 24-1. For example, images from cameras 14-1 and 14-2 may be transformed into a single image at the perspective of eye box 24-1.

In a stereoscopic display, first and second images are displayed for the left and right eyes of the user, respectively. Accordingly, images from the camera(s) may both be transformed to the perspective of the left eye box 24-1 and transformed to the perspective of the right eye box 24-2. In this way, an image that is displayed for the user's left eye at eye box 24-1 may align with the physical environment as viewed at eye box 24-1. An image that is displayed for the user's right eye at eye box 24-2 may align with the physical environment as viewed at eye box 24-2.

Depth information regarding the physical environment (e.g., from one or more depth sensors in system 10) may be used to transform the images from one or more camera(s) 14 to the perspective of eye boxes 24-1 and 24-2.

Transforming images as described herein (e.g., from the perspective of a camera to the perspective of one of the eye boxes) may be performed using an algorithm that receives at least an image from a camera as input. The algorithm may also use inputs such as images from one or more additional cameras, depth information, head pose information, etc. The algorithm may be based on the geometry of the system (e.g., the displacement between the camera and the eye box), calibration data, etc.

As one example, transforming the image from the perspective of a camera to the perspective of one of the eye boxes includes capturing an image of a scene (using the camera). Then, the device determines the depth of the scene (e.g., using one or more depth sensors in system 10). There are various ways (which may be used alone or in combination) for system 10 to determine the depth of the scene.

In some implementations, the system determines a plurality of pixel depths corresponding to a plurality of pixels of the image of the scene. The pixel depths are indicative of the distance between the system and an object (or a portion thereof) represented by the corresponding pixel. In various implementations, the pixel depths are determined using scene understanding, VIO (visual inertial odometry), a depth sensor, and/or depth by stereo.

In various implementation, the system determines a single depth. In various implementations, the system determines a first and second depth for the user's first and second eyes, respectively. In such implementations, the system reconciles the first and second depths in order to determine the depth of the scene. For example, in some implementations, the system averages the first and second depths in order to determine the depth of the scene.

In various implementations, the system determines the depth of the scene as one of the plurality of pixel depths corresponding to one of the plurality of pixels of the image at a center of the image. In this way, the system determines the depth of the scene as the distance between the system and an object the system is facing.

In various implementations, the system determines the depth of the scene as one of the plurality of pixel depths corresponding to one of the plurality of pixels of the image at a fixation point of the user in the image. In various implementations, the system includes an eye tracker (e.g., an inward facing camera and appropriate processing modules) that determines the fixation point of the user. In this way, the system determines the depth of the scene as the distance between the system and an object the user is looking at (e.g., an object that has focus).

In various implementations, the system determines the depth of the scene as the most frequent pixel depth among the plurality of pixel depths. For example, the system can generate a depth histogram of the pixel depths and select, as the depth, the bin of the depth histogram that represents the most pixels.

In various implementations, the system determines the depth based in part on a task being performed by the user. For example, in various implementations, in response to determining that the user is performing different tasks, such as sitting at a desk, sitting on a couch, walking around, or interacting (e.g., talking) with other people, the system can determine different depths and/or determine the depth using different heuristics.

Because the transformed images will be blurred before being viewed by the user, there may be a high tolerance in the accuracy of the transformed images. In other words, small offsets between the physical environment and the image of the physical environment may not ultimately be noticeable to the viewer since the image of the physical environment is blurred.

After determining the depth of the scene, the system may transform the image of the scene based on the determined depth and a difference between a point-of-view of the scene camera and a point-of-view of a user. In various implementations, the system transforms the image of the scene at an image pixel level, an image tile level, or a combination thereof.

In various implementations, the transformation is a homographic transformation. Thus, in various implementations, for each pixel of the image of the scene at a pixel location in an untransformed space, a new pixel location is determined in a transformed space.

In various implementations, the new pixel location is determined as a function of the pixel location in the untransformed space, the pixel location in the transformed space, a 3×3 view projection matrix of the eye representing the point-of-view of the user, a 3×3 view projection matrix of the scene camera representing the point-of-view of the scene camera, and the depth of the scene determined by the system.

In various implementations, the new pixel location is determined for each pixel in the image of the scene. In various implementations, the new pixel location is determined for less than each pixel of the image of the scene (e.g., for the four corners of the image of the scene with linear interpolation applied to determine other new pixel locations).

In various implementations, the device determines the view projection matrix of the eye and the view projection matrix of the scene camera during a calibration and stores data indicative of the view projection matrices (or their product) in a non-transitory memory.

Thus, in various implementations, transforming the image of the scene includes determining, for a pixel having a pixel location, a new pixel location by multiplying a vector including the pixel location and the depth by a transformation matrix representing a difference between the point-of-view of the scene camera and the point-of-view of the user.

Using the new pixel locations in the transformed space and the pixel values of the pixels of the image of the scene, the device generates a transformed image using interpolation or other techniques.

The aforementioned examples for transforming images from the perspective of a camera to the perspective of one of the eye boxes is merely illustrative. In general, any desired image transformation techniques may be used to transform images from the perspective of a camera to the perspective of one of the eye boxes.

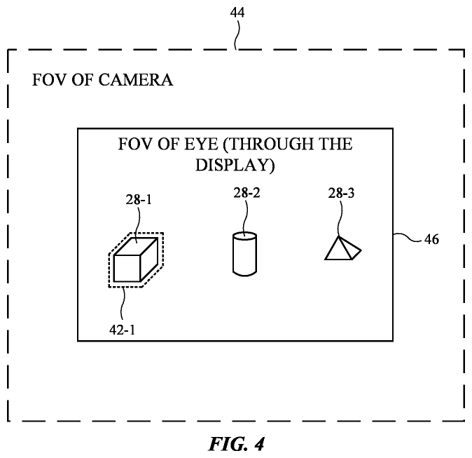

In addition to transforming images from the cameras, control circuitry within device 10 may crop images from the cameras. FIG. 4 is a diagram showing the field of view (FOV) 44 of a camera (e.g., camera 14-3 in FIG. 3A). Camera 14-3 may capture image data for the field of view 44 but not outside of field of view 44. The field of view of a user at eye box 24-1 through transparent display 20 is represented by field of view 46 in FIG. 4. As shown, physical objects 28-1, 28-2, and 28-3 are visible in field of view 46.

As shown in FIG. 4, FOV 46 is a subset of FOV 44. In other words, camera 44 may capture image data for a portion of the physical environment that is not viewable through transparent display 20. To conserve processing power, control circuitry 16 may not transform this portion of the image to the perspective of the eye box (since this portion of the physical environment is not viewable through the transparent display). Accordingly, the image data from the camera (corresponding to FOV 44) may be cropped to align with FOV 46 before the image is transformed. It should be noted that due to warping during the transformation between the camera space and the display space, the image data from the camera may be cropped to an area that is larger than FOV 46 to ensure that there is adequate image data from the camera to fully populate the transformed image within FOV 46. When only a subset of the physical environment that is viewable through transparent display 20 is intended to be blurred (e.g., a blur panel 42-1), the image data may be cropped further to only include the area of blur panel 42-1 before being transformed. Again, it is noted that the image data from the camera may be cropped to an area that is larger than the subset that is intended to be blurred (e.g., blur panel 42-1) to ensure that there is adequate image data from the camera to fully populate the subset that is intended to be blurred. Cropping the image before transforming conserves processing power compared to transforming all of FOV 44 and then later cropping the transformed image.

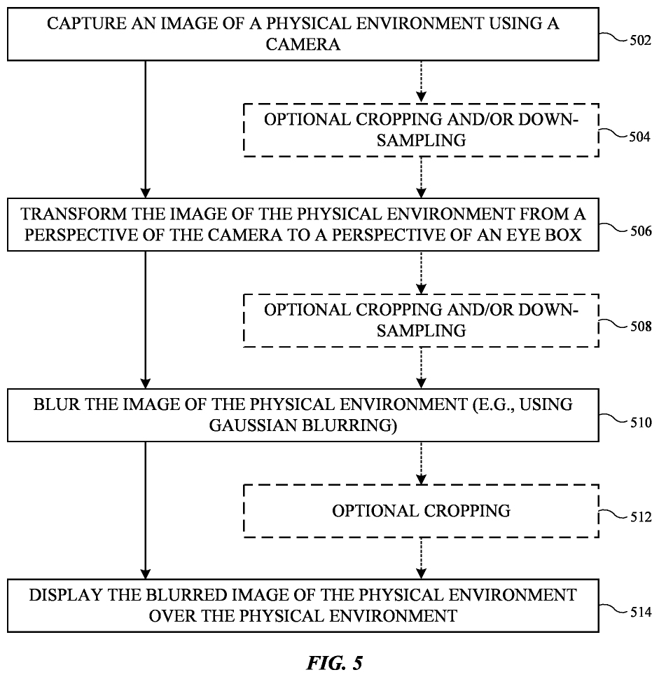

FIG. 5 is a flowchart showing an illustrative method performed by an electronic device (e.g., control circuitry 16 in device 10). The blocks of FIG. 5 may be stored as instructions in memory of electronic device 10, with the instructions configured to be executed by one or more processors in the electronic device.

At block 502, the control circuitry may use a camera (e.g., one of cameras 14 in FIG. 1) to capture an image of a physical environment surrounding device 10. The camera may be, for example, an outward-facing camera on a head-mounted device that faces away from the user while the head-mounted device is supported on the user's head.

While the device is worn on the user's head, the physical environment may be viewed by the user through a transparent display in the head-mounted device. Computer-generated content that overlays the physical environment may also be displayed on transparent display 20 while the device is worn on the user's head. The camera may capture an image of a portion of the physical environment that is viewable through the transparent display at block 502.

At block 506, the image of the physical environment may be transformed from a perspective of the camera to a perspective of an eye box. Control circuitry 16 may include a transforming algorithm that outputs a transformed image based on a received input image from the camera. The transforming algorithm may optionally use other inputs (e.g., input images from additional cameras, depth information, scene characterization information, etc.).

It is noted that in some cases (e.g., depending on the position and resolution of the camera capturing the image), the transforming step 506 may be omitted.

At block 510, the control circuitry may blur the image of the physical environment. As an example (e.g., as shown in FIG. 5), the control circuitry may blur the transformed image of the physical environment. However, this example is merely illustrative. If desired, blocks 506 and 510 may be flipped such that the image from camera 502 is blurred and then subsequently transformed.

Any desired blurring techniques may be used at block 510 (e.g., Gaussian blur, defocus blur, box blur, etc.). The specific properties (e.g., strength) of the applied blur may be adjustable based on the particular application for the blurred content. Different blur panels in different portions of the display may also be blurred by different amounts. For example, a first blur panel may be blurred by a first amount whereas a second blur panel may be blurred by a second amount that is greater than the first amount.

At block 514, the transformed and blurred image of the physical environment is displayed on transparent display 20. Because the image is transformed, the image overlays the physical environment when viewed by the viewer. This adds a blur effect of the physical environment to the user.

The blur panel displayed at block 514 may optionally be displayed at an apparent depth (e.g., an apparent distance from the device) that matches the actual depth of the physical environment included in the blur panel. The apparent depth of the blur panel may vary or may be fixed.

Because the displayed image of the physical environment is blurred, the image obtained by camera 14 at block 502 need not have a high resolution. To leverage this, camera 502 may sometimes capture images at a low resolution. Camera 14 may have a fixed, low resolution or may be operable in a high-resolution mode and a low-resolution mode. The low resolution may be lower than the high resolution by at least 25%, by at least 50% by at least 75%, etc. When control circuitry 16 determines that the image data from camera 14 will be used for a blur panel, the control circuitry may place the camera in the low-resolution mode. Using low resolution data for subsequent processing in blocks 506 and 510 may reduce processing power and memory requirements.

Alternatively, camera 502 may capture images at a high resolution and the images may then be down-sampled at optional block 504. The down-sampling reduces the resolution of the image before subsequent processing (e.g., transforming in block 506 and/or blurring in block 510), which reduces processing power and memory requirements. The down-sampling may, as an example, reduce the resolution of the image from a first resolution to a second resolution that is lower than the first resolution (e.g., by at least 25%, by at least 50% by at least 75%, etc.).

The example of down-sampling at block 504 is merely illustrative. If desired, down-sampling may be performed at optional block 508 (e.g., after transforming the image in block 506). Down-sampling at block 508 may reduce processing power and memory requirements for subsequent blurring operations in block 510. Down-sampling in block 508 may, as an example, reduce the resolution of the image from a first resolution to a second resolution that is lower than the first resolution (e.g., by at least 25%, by at least 50% by at least 75%, etc.).

Cropping may also optionally be performed at blocks 504, 508, and 512 in FIG. 5. In general, cropping may be performed at any time during the process of FIG. 5 (given the control circuitry has determined which portion of the physical environment will be blurred on the display). Cropping may be performed in one step or in multiple steps.

As an example, a first cropping operation in block 504 may crop the image data from the camera FOV 44 to the FOV 46 of the eye through the display (see FIG. 4). A second cropping operation in block 508 or block 512 may crop the image data from the FOV of the eye through the display to the blur panel(s) intended to be displayed.

Instead of a two-step cropping operation, the cropping may be performed in a single operation at block 504, block 508, or block 512. For example, at block 504, a single cropping operation may crop the image data from the camera FOV 44 to the blur panel(s) intended to be displayed (which may include any subset of FOV 46 in FIG. 4).

If desired, cropping, down-sampling, transforming, and/or blurring operations may be performed by control circuitry within the camera capturing the image (e.g., within an image signal processor (ISP) for the camera). This may reduce the size and/or resolution of the image data output from the camera, which may be advantageous for privacy and security considerations.

For example, camera 14 may output a blurred image of the physical environment. Alternatively or in addition, camera 14 may only output images of the physical environment that correspond to FOV 46 of the eye through the display.

Because the image of the physical environment ultimately displayed is blurred, there may be a high tolerance in the margin for error of the transform operation in block 506. The transform operation may sacrifice accuracy to conserve processing power since the subsequent blurring means that a high degree of accuracy is not noticeable/required.

The order of the blocks presented in FIG. 5 is merely illustrative. In general, the operations of the blocks in FIG. 5 may be performed in any desired order (e.g., block 506 may be performed before block 510 or vice versa).

Each operation in FIG. 5 may be performed at a frequency that is equal to or similar to (e.g., within 5% of, within 10% of, within 20% of, within 50% of, etc.) a frame rate for display 20 (e.g., 1 Hz, 60 Hz, 100 Hz, 120 Hz, more than 80 Hz, more than 60 Hz, more than 30 Hz, less than 120 Hz, etc.). In other words, the system may repeatedly perform the operations of blocks 502-514 in FIG. 5 such that the blurred image of the physical environment is continuously displayed over the physical environment. The most recent image from a video feed from the camera may be used for the subsequent processing operations. The subsequent processing operations (e.g., blurring, warping, downsampling and/or cropping) are therefore also performed in real time on the most recent image from the video feed. A blurred image of the physical environment may be immediately displayed on transparent display 20 (e.g., in the next possible frame) to mitigate latency. This scheme for repeatedly displaying the blurred image of the physical environment over the physical environment may sometimes be referred to as displaying the real time blurred image of the physical environment over the physical environment. The image from block 502 may be part of a real time video feed from the camera.

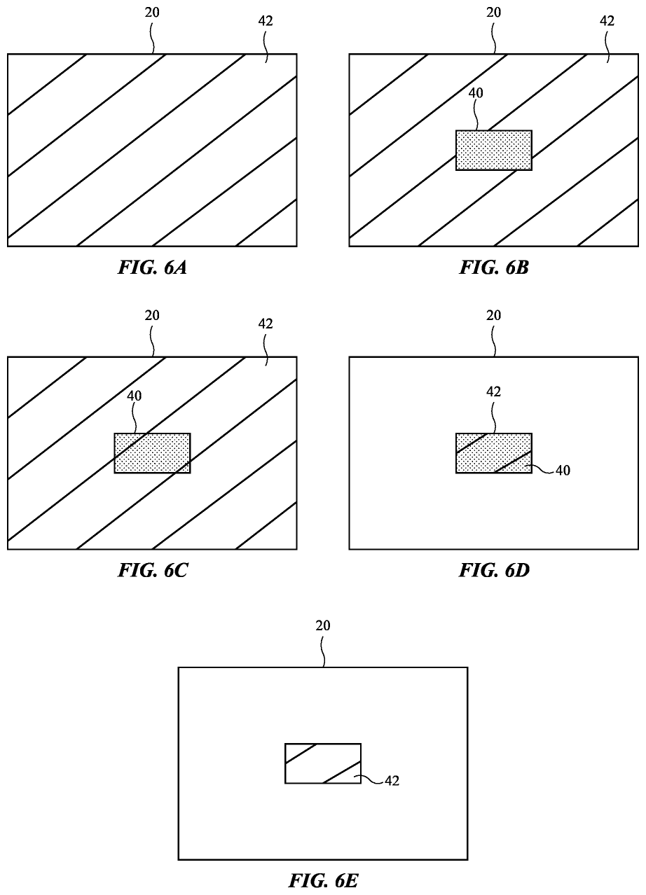

In general, the blur effect (blur panel) may be applied to any or all of the physical environment viewable through transparent display 20. FIGS. 6A-6E show different arrangements for a blur panel on transparent display. In FIG. 6A, blur panel 42 occupies the entire display. In other words, the blur effect is applied to all of the physical environment that is viewable through display 20.

In FIG. 6B, computer-generated content 40 is displayed on display 20 in addition to blur panel 42. In FIG. 6B, the blur effect is not applied to the physical environment overlayed by computer-generated content 40. The blur panel 42 therefore occupies all of the physical environment that is viewable through display 20 except for the region of the display that includes the computer-generated content. As an example, computer-generated content 40 may include text. In this case, the text would be viewable on an unblurred version of the physical environment that is viewable through transparent display 20.

In FIG. 6C, computer-generated content 40 is again displayed on display 20. In this arrangement, the blur effect is applied to all of the physical environment that is viewable through display 20 (including the portion of the physical environment that is overlayed by computer-generated content 40). In other words, computer-generated content 40 is merged with the blurred version of the physical environment. As an example, computer-generated content 40 may include text. In this case, the text would be viewable on a blurred version of the physical environment that is viewable through transparent display 20. A blurred version of the physical environment is viewable through the remaining portions of transparent display 20.

In FIG. 6D, the blur effect is applied to only the portion of the physical environment that is overlayed by computer-generated content 40. In other words, computer-generated content 40 is merged with the blurred version of the physical environment. As an example, computer-generated content 40 may include text. In this case, the text would be viewable on a blurred version (42) of the physical environment that is viewable through transparent display 20. An unblurred version of the physical environment is viewable through the remaining portions of transparent display 20.

In FIG. 6E, the blur effect is applied to only a subset of the physical environment that is viewable through display 20. In FIG. 6E, blur panel 42 is a patch (sometimes referred to as an island) that is laterally surrounded by unblurred areas where the unblurred version of the physical environment is viewable through the transparent display 20. This example is merely illustrative. In general, blur panel(s) 42 may occupy one or more subsets of transparent display 20. Each blur panel may have any desired shape and size.

Each blur panel may optionally be head-locked, world-locked, or body-locked. For example, a first blur panel may be world-locked while a second blur panel on the same transparent display may be head-locked. The world-locked blur panel may remain fixed relative to the physical environment. For example, a world-locked blur panel may be applied to physical object (e.g., a display, a document, a window, a background, etc.) within the user's field of view. The world-locked blur panel may be applied to a physical location (such that the world-locked blur panel remains in the same physical location even if one or more physical objects in the physical environment move). As the user moves their head and/or body, the pose of the electronic device relative to the physical environment changes. However, the world-locked blur panel remains fixed on the corresponding physical object.

A head-locked blur panel may remain fixed in a given position relative to the head-mounted device (and therefore the user's head which is supporting the head-mounted device). A body-locked blur panel may be displayed at a location that is defined relative to a portion of the user of the head-mounted device (e.g., relative to the user's torso).

As one possible use case for a blur panel, consider an example where a user is operating a head-mounted device while working in a coffee shop. The user may have a workspace including a table, laptop, and notebook. To avoid distractions, a blur panel may be applied to the user's background while leaving their workspace (e.g., the table, laptop, and notebook) unblurred.

As another possible use case, consider a passenger on an airplane that is operating a head-mounted device. A blur panel may be world-locked to a neighboring passenger's seatback display to avoid distractions for the passenger.

As another possible use case, consider an example where a user of a head-mounted device opens a meditation application. The meditation application may apply a blur panel to the entire field of view of the user through the transparent display.

As another possible use case, consider an example where a user notification is displayed on transparent display 20. A blur effect may be applied to the remainder of the display around the user notification and/or to the background of the user notification.

Out of an abundance of caution, it is noted that to the extent that any implementation of this technology involves the use of personally identifiable information, implementers should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made to the described embodiments. The foregoing embodiments may be implemented individually or in any combination.

What is claimed is:

1. A method of operating a head-mounted device with a camera and a display, the method comprising:
capturing an image of a physical environment using the camera;
emitting light from a transparent structure towards an eye box using the display, wherein the physical environment is viewable through the transparent structure from the eye box;
warping the image of the physical environment from a perspective of the camera to a perspective of the eye box; and
displaying, using the display, a blurred portion of the warped image of the physical environment at a position that overlaps a corresponding portion of the physical environment.

2. The method defined in claim 1, further comprising:
before warping the image of the physical environment from the perspective of the camera to the perspective of the eye box, down-sampling the image of the physical environment from a first resolution to a second resolution that is lower than the first resolution.

3. The method defined in claim 1, further comprising:
before warping the image of the physical environment from the perspective of the camera to the perspective of the eye box, cropping the image of the physical environment to only include a portion of the image of the physical environment corresponding to a portion of the physical environment that is visible through the transparent structure from the eye box.

4. The method defined in claim 3, wherein the blurred portion of the warped image of the physical environment comprises the entire portion of the image of the physical environment corresponding to the portion of the physical environment that is visible through the transparent structure from the eye box.

5. The method defined in claim 1, further comprising:
before warping the image of the physical environment from the perspective of the camera to the perspective of the eye box, blurring at least the portion of the image of the physical environment.

6. The method defined in claim 1, further comprising:
after warping the image of the physical environment from the perspective of the camera to the perspective of the eye box, blurring at least the portion of the image of the physical environment.

7. The method defined in claim 1, wherein displaying the blurred portion of the warped image comprises displaying the blurred portion of the warped image at a fixed position relative to the head-mounted device.

8. The method defined in claim 1, further comprising:
cropping the image of the physical environment from a first size to a second size that is smaller than the first size.

9. The method defined in claim 8, further comprising, after cropping the image of the physical environment from the first size to the second size:
cropping the image of the physical environment to only include a subset of the physical environment corresponding to the blurred portion of the warped image.

10. The method defined in claim 1, wherein the image of the physical environment is part of a real time video feed.

11. The method defined in claim 10, wherein warping the image of the physical environment comprises warping a most-recent image of the physical environment from the real time video feed and wherein displaying the blurred portion of the warped image of the physical environment comprises displaying the blurred portion of the warped most-recent image of the physical environment from the real time video feed.

12. An electronic device comprising:
a camera configured to capture an image of a physical environment;
a display that emits light from a transparent structure towards an eye box, wherein the physical environment is viewable through the transparent structure from the eye box; and
control circuitry configured to:
warp the image of the physical environment from a perspective of the camera to a perspective of the eye box; and
using the display, display a blurred portion of the warped image of the physical environment at a position that overlaps a corresponding portion of the physical environment.

13. The electronic device defined in claim 12, wherein the control circuitry is further configured to:
before warping the image of the physical environment from the perspective of the camera to the perspective of the eye box, blurring the image of the physical environment.

14. The electronic device defined in claim 12, wherein the control circuitry is further configured to:
before warping the image of the physical environment from the perspective of the camera to the perspective of the eye box, down-sampling the image of the physical environment from a first resolution to a second resolution that is lower than the first resolution.

15. The electronic device defined in claim 12, wherein the control circuitry is further configured to:
before warping the image of the physical environment from the perspective of the camera to the perspective of the eye box, cropping the image of the physical environment to only include a portion of the image of the physical environment corresponding to a portion of the physical environment that is visible through the transparent structure from the eye box.

16. The electronic device defined in claim 15, wherein the blurred portion of the warped image of the physical environment comprises the entire portion of the image of the physical environment corresponding to the portion of the physical environment that is visible through the transparent structure from the eye box.

17. An electronic device comprising:
a head-mounted support structure;
a camera coupled to the head-mounted support structure, wherein the camera is configured to capture an image of a physical environment;
a display coupled to the head-mounted support structure, wherein the display emits light from a transparent structure towards an eye box and wherein a subset of the physical environment is viewable through the transparent structure from the eye box; and
control circuitry configured to, using the image of the physical environment captured by the camera, display a blurred image of the subset of the physical environment that overlaps the subset of the physical environment when viewed through the transparent structure from the eye box.

18. The electronic device defined in claim 17, wherein the control circuitry is configured to, before displaying the blurred image:
warp the image of the physical environment from a perspective of the camera to a perspective of the eye box.

19. The electronic device defined in claim 18, wherein the control circuitry is configured to, after warping the image of the physical environment from the perspective of the camera to the perspective of the eye box:
blur the image of the physical environment.

20. The electronic device defined in claim 17, wherein the control circuitry is configured to, before displaying the blurred image:
blur the image of the physical environment; and
after blurring the image of the physical environment, warp the image of the physical environment from a perspective of the camera to a perspective of the eye box.
